(19) United States
(12) Patent Application Publication
(10) Pub. No.: US 2013/0246147 A1
(43) Pub. Date: Sep. 19, 2013

(54) SYSTEM AND METHOD FOR PROVIDING IMAGING AND OTHER DIGITAL REPRESENTATIONS OF RECEIPTS TO IMPART INCENTIVES ON USERS

(71) Applicants: Dazhi CHEN, New York, NY (US); Gerrine PAN, New York, NY (US); Seema REVANKAR, Jersey City, NJ (US); Jimmy RAU, Flushing, NY (US); Tyler BORENSTEIN, New York, NY (US); Xinge DU, New York, NY (US)

(72) Inventors: Dazhi CHEN, New York, NY (US); Gerrine PAN, New York, NY (US); Seema REVANKAR, Jersey City, NJ (US); Jimmy RAU, Flushing, NY (US); Tyler BORENSTEIN, New York, NY (US); Xinge DU, New York, NY (US)

(73) Assignee: Dailygobble, Inc., New York, NY (US)

(21) Appl. No.: 13/738,419

(22) Filed: Jan. 10, 2013

Related U.S. Application Data
(60) Provisional application No. 61/610,732, filed on Mar. 14, 2012.

(51) Int. Cl. G06Q 30/02

(52) U.S. Cl. CPC G06Q 30/0226
USPC 705/14.25

(57) ABSTRACT

The disclosure relates to systems and methods for providing a card-less reward program that awards rewards based on purchase data determined from digital representations of sales receipts, and facilitating analytics related to the reward program, feedback from customers, and detection of fraudulent reward redemptions. A reward server may receive a digital representation of a sales receipt, determine purchase data based on the digital representation, and determine one or more rewards to be awarded based on the determined purchase data. The reward server may generate a code in association with the one or more rewards that can be used for auditing purposes to determine whether a reward was fraudulently obtained. The reward server may provide analytics and customer surveys to determine the effectiveness of reward programs and/or other merchant efforts to build and enhance customer loyalty.

### CROSS REFERENCE TO RELATED APPLICATIONS

This application claims priority to U.S. Provisional Patent Application Ser. No. 61/610,732, entitled “System and Method for Providing Imaging and other Digital Representations of Receipts to Impart Incentives on Users,” filed on Mar. 14, 2012, which is incorporated by reference in its entirety herein.

### FIELD OF THE INVENTION

The invention relates to systems and methods for providing a card-less reward program that awards rewards based on purchase data determined from digital representations of sales receipts, and facilitating analytics related to the reward program, feedback from customers, and detection of fraudulent reward redemptions.

### BACKGROUND

Loyalty programs generally encourage customers to make repeated purchases and are typically administered using a loyalty card that is associated with a customer's loyalty account. The customer presents the loyalty card during a purchase transaction, which is generally stored in association the customer's loyalty account. Some loyalty programs provide promotional offers that provide rewards to entice purchases. The rewards may include reward points, discounts off items such as products or services, free items, and/or other rewards based on the customer's purchases.

However, the ubiquity of loyalty programs has led to an ebbing of their impact. Many customers possess so many loyalty cards and participate in so many loyalty programs that the influence of such programs has come down.

Customers often do not have a specific loyalty card on hand at a point of sale (in a store, restaurant, hotel, rental car office, airport, etc.), or do not remember which cards they have and which of them can be applied. Moreover, many stores do not apply discounts or reward customers when customers do not have their loyalty cards on hand. As a result, many customers do not actively participate in loyalty programs even after they have been enrolled.

In addition to loyalty cards, coupons are also an effective way to attract new customers or encourage current customers. Coupons are paper tickets or electronic documents that can be exchanged for a financial discount or rebate when purchasing a product or service. Traditionally, coupons are issued by manufacturers or by retailers, to be used in retail stores or restaurants as a part of sales promotions. They are often widely distributed through mail, magazines, newspapers, the Internet, and mobile devices such as mobile phones. In general, coupons can be redeemed at the time of purchase by a customer showing a coupon to a cashier at the Point of Sale (POS). Customers are then given a financial discount, rebate, free product or service.

Delivery of printed paper coupons is traditionally expensive for the marketer. In addition to the cost of printing and delivering, the marketer also incurs the costs of training personnel to accept the coupons at a POS. Moreover, there can be fraud in redeeming paper coupons.

In recent years, paperless coupons are widely used by marketers or retailers. Such paperless coupons can be delivered via the Internet, e-mails, mobile messages like SMS, media messages, or the like. The coupons can be redeemed at merchants without the need of printing those coupons, as they can be shown at the POS directly via the mobile phone, smart phone, PDA, etc.

However, although marketers or retailers avoid the costs of printing and delivery of the paperless offers, they still face significant costs associated with fraud, training of staff at stores to accept and process coupons, and installing any software at the POS.

In addition, the customers often forget to redeem (paper or paperless) coupons because it can be difficult to find needed coupons or even remember that they have coupons that can be applied to their purchases. Further, customers may forget to take their coupons with them to a store or may not have coupons with them for other reasons. Moreover, in many instances, customers would like to enjoy anonymity, and not be embarrassed with bringing coupons, for example, at a restaurant or a store.

Accordingly, a need exists for rewarding customers for a purchases without coupons or loyalty cards, detecting fraud, and analyzing loyalty program effectiveness. These and other problems exist.

### SUMMARY OF INVENTION

The invention relates to systems and methods for providing a card-less reward program that awards rewards based on purchase data determined from digital representations of sales receipts, and facilitating analytics related to the reward program, feedback from customers, and detection of fraudulent reward redemptions.

In some implementations, the system may include a reward server that includes one or more processors configured to perform some or all of a functionality of a plurality of modules. For example, the one or more processors may be configured to execute a receipt processing module, a reward module, an audit module, a survey module, a marketing module, a report and analysis module, an account management module, and/or other modules.

In some implementations, the receipt processing module may be configured to receive a digital representation of the sales receipt. The digital representation can include, for example, a picture or video of at least a portion of the sales receipt, an electronic document that includes the purchase data, and/or other format that can convey the purchase data. In some implementations, the digital representation can be processed by the receipt processing module using optical character recognition to recognize text (e.g., letters, numbers, characters, etc.) and/or read by a human operator. In some implementations, the digital representation includes a machine readable code such as a bar code or QR code that can be decoded by the receipt processing module to reveal the purchase data or a transaction identifier associated with the purchase data. In some implementations, the digital representation includes text that requires no optical recognition or decoding. For example, in these implementations, the text may be received from customer user device, which obtained the purchase information from the merchant using various techniques described above.

In some implementation, the reward module may determine a reward based on the purchase data. In some implementations, for example, a reward may vary based on a purchase amount (e.g., price paid as indicated on the sales receipt), an identity of the item that was purchased, a location where the purchase occurred, a merchant from which the item was purchased, and/or other purchase data as indicated by the sales receipt.

In some implementations, the reward module may associate the reward with the customer in a reward database. For example, the reward database may store a reward account for the customer. In some implementations, the reward module may present the redeemable reward as an electronic voucher. For example, the electronic voucher may be communicated to a customer user device, and the electronic voucher can be presented to the merchant. In some implementations, the voucher may be communicated to the merchant so that the next time the associated customer makes a purchase, the voucher may be automatically applied to the next purchase.

In some implementations, the reward module may be configured to generate a code related to a reward. An association of the code and the reward may be stored in the reward database. The stored association may be used for audit and/or fraud detection purposes.

The reward module may cause the code to be communicated for display to the customer user device, where the code is displayed for redemption. For example, the code may be displayed or otherwise communicated from the customer user device to the merchant user device to receive from the merchant the reward associated with the code and/or the code may be read by an employee of the merchant and entered into the merchant user device.

In some implementations, the customer user device may display along with the code a timer that displays a time related to reward redemption. For example, the timer may include a countdown timer that when expires such as by reaching zero, the reward may be deemed to be redeemed, expired, or otherwise unusable. In some implementations, the reward expires when the countdown timer expires. In some implementations, the reward does not expire such that the customer may simply request a new code. In some implementations, the timer counts up such that when the timer reaches a predefined time, the reward may be deemed to be redeemed, expired, or otherwise unusable.

In some implementations, the reward module may cause a description of the reward such as a free item to be communicated for display. In these implementations, the customer user device may display the description of the reward.

In some implementations, the merchant user device may receive the code and cause the reward associated with the code to be awarded to the customer. The code may be received by various communication channels such as via an input pad of the merchant user device, from the customer user device, and/or other communication channel. The merchant user device may locally store an association between the reward that was awarded and the code for later auditing purposes.

In some implementations, the customer user device may display the code, the reward, and the countdown timer. In these implementations, the merchant may award the reward displayed on the customer user device as long as the countdown timer has not expired. The code may not be validated and may simply be recorded for auditing purposes later. For example, the reward may be related to a free brownie to be awarded to the customer. The customer user device may display “free brownie” or other message that indicates the reward along with the countdown timer and the code. An employee of the merchant may award the brownie and enter the code into merchant user device for later auditing.

In some implementations, the merchant user device may cause the reward to be awarded without first validating the code. In these implementations, the merchant user device need not contact the reward server to validate the code but instead locally keeps a record of the code and the reward so that the reward may be audited later (e.g., on a nightly basis, after an employee shift, and/or other times) during a batch or other process.

In some implementations, the audit module may receive an audit request. For example, the audit module may receive the audit request from the merchant user device so that the merchant may determine whether a reward was fraudulently obtained (e.g., by an employee or other user). In some implementations, the audit request may request valid codes communicated from reward server. In these implementations, the audit module may provide the codes that were previously communicated from the reward server so that the merchant may locally compare the codes with the locally stored codes that were associated with reward redemptions.

In some implementations, the audit request may include one or more codes to validate. In these implementations, the audit module may compare the included one or more codes with the codes stored in the reward database. When the included one or more codes do not match the codes stored in the reward database, the audit module may communicate an indication that the one or more codes are invalid and may have been fraudulently entered (e.g., by an employee who made up the one or more codes to obtain an award).

In some implementations, the survey module may obtain and store one or more survey questions to be presented as a survey to the customer. In this manner, customer feedback may be obtained and presented to the merchant.

In some implementations, the marketing module may generate marketing campaigns based on a purchase history of a customer. For example, the purchase history may be generated based on the receipts (or purchase data) submitted by the customer. The marketing module may analyze the purchase history and generate a customer profile, which may be used to generate a marketing campaign (e.g., a direct 1-to-1 marketing campaign) tailored for the customer.

In some implementations, the report and analysis module may generate a Dashboard that includes various reports and analytics that may be used to review, monitor, and manage customer data. In some implementations, the purchase data, submitted receipts, customer profile, promotions or vouchers communicated to the customer, promotions or vouchers redeemed by the customer, survey feedback, and/or other customer information may be displayed by the Dashboard, which displays the data in an easily analyzable format.

In some implementations, the Dashboard may be parsed by individual customer, customer group, merchant location, merchant offer (digital voucher or coupon created for customers), survey feedback, and/or by other customer information.

In some implementations, the Dashboard may include an analytical representation of data includes charts, graphs, tables, customer profiles, etc. In some implementations, the Dashboard can include data from an individual merchant, data from merchants handled by the reward server, or data external to merchants. In this manner, a particular merchant may compare their performance with another merchant's performance. For example, a restaurant may compare their monthly sales among their own locations to other merchants' sales or to industry-wide sales).

In some implementations, the account management module may be configured to create, manage, and update various profiles associated with the rewards program. For example, the profiles may include a merchant account profile, a buyer account profile, and/or other profiles.

By allowing a customer to show proof of purchase using, for example, a mobile device equipped with a camera, the system facilitates an improved way to administer rewards without the need for reward cards or enticing the customer with particular promotional offers before making the purchase. Instead, a customer may walk into a merchant location (or navigate to a merchant's online site), make a purchase, obtain a digital representation of a sales receipt, and obtain a reward based on the purchase. The system may also facilitate detection of fraud while implementing an easy way to convey codes that relate to rewards as well as integrate analytics and reporting to determine the effectiveness of loyalty programs and/or other merchant efforts to build and retain business.

Various other objects, features, and advantages of the invention will be apparent through the detailed description of the invention and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a block diagram of a card-less reward system providing a possibility to participate in a reward program by customers and merchants in accordance with various embodiments of the present invention.

FIG. 2 illustrates a block diagram of a reward system presented at FIG. 1 according to exemplary embodiments of the invention.

FIG. 3 is a flow diagram illustrating a process for providing a card-less reward program at a reward server, according to various implementations of the invention.

FIG. 4 is a flow diagram illustrating a process for providing a card-less reward program at a mobile device, according to various implementations of the invention.

FIG. 5 is a screenshot that illustrates a user interface for submitting a sales receipt, according to various implementations of the invention.

FIG. 6 is a screenshot that illustrates a user interface for taking a picture of a sales receipt, according to various implementations of the invention.

FIG. 7 is a screenshot that illustrates a user interface for presenting rewards and offers, according to various implementations of the invention.

FIG. 8 is a screenshot that illustrates a user interface for presenting a survey associated with a purchase, according to various implementations of the invention.

FIG. 9 is a screenshot that illustrates a user interface for displaying analytics associated with a card-less reward program, according to various implementations of the invention.

FIG. 10 is a screenshot that illustrates a user interface for displaying analytics grouped by location in association with a card-less reward program, according to various implementations of the invention.

FIG. 11 is a screenshot that illustrates a user interface for displaying survey results grouped by location in association with a card-less reward program, according to various implementations of the invention.

FIG. 12 is a screenshot that illustrates a user interface for displaying survey results by individual customers in association with a card-less reward program, according to various implementations of the invention.

FIGS. 13A and 13B are screenshots that illustrate user interfaces 1300A and 1300B for displaying a reward, a code, and a timer, according to various implementations of the invention.

FIG. 14 is a flow diagram illustrating a process for providing an audit of codes related to rewards for fraud detection, according to various implementations of the invention.

FIG. 15 is a flow diagram illustrating a process for flagging potentially fraudulently entered codes, according to various implementations of the invention.

FIG. 16 is a flow diagram illustrating a process for displaying codes for redemption of rewards, according to various implementations of the invention.

### DETAILED DESCRIPTION

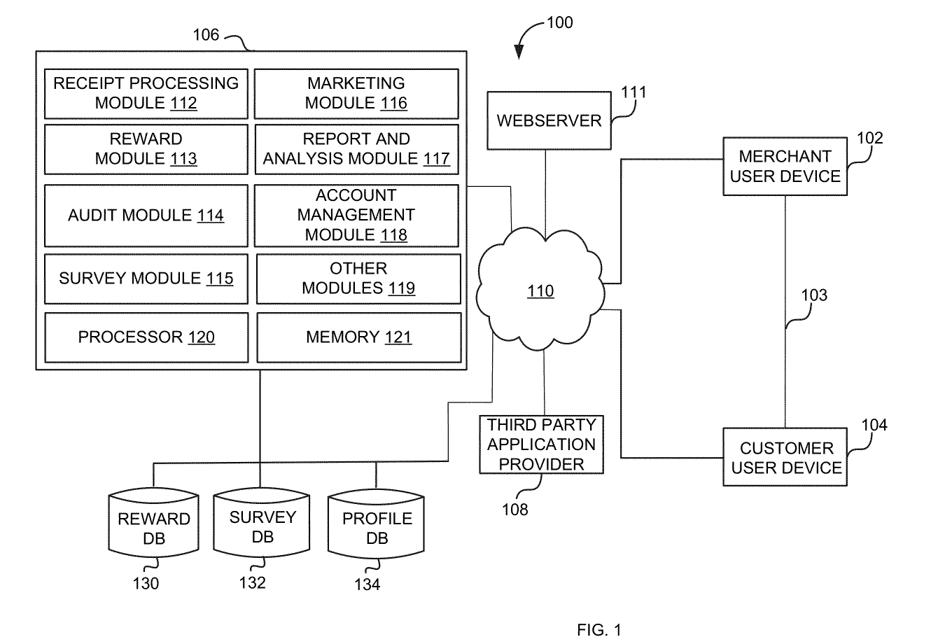

FIG. 1 illustrates a block diagram of a system 100 for providing a card-less reward program, according to various implementations of the invention. In some implementations, system 100 allows a customer to take a picture of a sales receipt using a mobile device, communicate the picture to a rewards server, and obtain a reward based on information processed from the picture. For example, the purchase data may be printed as text on the sales receipt, which can be processed using optical character recognition and/or read by a human operator associated with the reward server or merchant. In some implementations, the purchase data may be associated with a transaction identifier that is encoded as a bar code or QR code, which can be decoded to reveal the transaction identifier. In these implementations, the decoded transaction identifier may be used to look up the purchase data. In some implementations, the purchase data may be used to determine whether a reward should be awarded to the customer. Different types of reward programs may be used. For example, U.S. patent application Ser. No. 13/152,308, entitled “Method and Apparatus for Providing Cardless Reward Program,” filed on Jun. 3, 2011, which is incorporated by reference in its entirety herein, describes a cardless reward program.

In some implementations, the customer may obtain the reward even though the customer did not pre-select a particular promotional offer before making the purchase. Instead, the customer may simply visit a merchant without pre-selecting a particular promotional offer, make a purchase, take a picture of the receipt (for example), and obtain a reward based on the purchase. In this manner, system 100 provides a card-less reward program that rewards a customer for making a purchase while not requiring the customer to select a promotion before the purchase.

The foregoing example is non-limiting; other examples, uses, and implementations of the invention are described below and will also be apparent to those having skill in the art based on this disclosure. For example, the customer may receive and communicate the purchase data in various ways other than taking a picture of a sales receipt and may use various customer user devices 104 other than a mobile device to communicate the purchase data or sales receipt.

Referring to FIG. 1, system 100 may include, for example, a customer user device 104, a reward server 106, a merchant user device 102, and a network 110. Customer user device 104, reward server 106, and/or merchant user device 102, may be coupled to one another via network 110. In some implementations, network 110 may include, for example, the Internet, an intranet, a wired network, a wireless network, a public switched telephone network, and/or other network.

In some implementations, customer user device 104 may be coupled to merchant user device 102 via a link 103. Link 103 may include, for example, a BLUETOOTH connection, near-field communication protocol, direct wired link, or other communication link that can connect two devices that are within close proximity of one another (e.g., are in the same room or location).

In some implementations, merchant user device 102 may include various devices (not illustrated in FIG. 1) such as a point of sale device, a printer device that generates a printed sales receipt, various data ports that can be used to electronically convey the purchase data via an electronic sales receipt or other format, and/or other devices that can be used by the merchant to facilitate sales or marketing campaigns.

In some implementations, upon completion of a purchase, merchant user device 102 may generate a sales receipt that includes the purchase data. The purchase data may include, for example, an identification of a product, a service, a merchant, a location of the merchant, a price (e.g., a price of an individual item or a total price of more than one item), a discount/promotional offer applied to the purchase, and/or other information associated with a purchase that can be conveyed by a sales receipt.

In some implementations, the sales receipt may be printed. For example, in some implementations, merchant user device 102 may cause text or characters to be printed on the sales receipt in a conventional manner. In these implementations, customer user device 104 may generate a digital representation (i.e., take a picture) of the sales receipt. The picture may then be processed using optical character recognition in order to determine the text or characters printed on the sales receipt. In some implementations, a bar code or QR code may be printed on the sales receipt. In these implementations, the picture of the bar code or QR code may be decoded to reveal the purchase data or an identifier that can be used to look up the purchase data.

In some implementations, the sales receipt may be electronic. For example, in some implementations, merchant user device 102 may generate a digital representation (e.g., a portable document format file or other electronic format) that electronically conveys the sales receipt.

In some implementations, using merchant user device 102, a merchant may register with a rewards program. The merchant registration may include merchant information such as, for example, an identity of the merchant, merchant locations (including brick-and-mortar and online locations), merchant products, promotions, rewards, and/or other information that a merchant may wish to convey to participate in the rewards program. In some implementations, the merchant information may include instructions that indicate data/fields to parse when processing a sales receipt from the merchant. For example, the merchant may specify a receipt format so that purchase data from the sales receipt may be parsed. In some implementations, the merchant information may include verification data that may be periodically (e.g., hourly, daily, weekly, etc.) changed by the merchant so that receipt spoofing is minimized.

In some implementations, customer user device 104 may obtain the purchase data from the merchant in various ways. For example, in some implementations, the customer may receive the purchase data via a printed sales receipt from the merchant and take a picture of the receipt using customer user device 104. In some implementations, customer user device 104 may communicate the picture to a remote device (such as reward server 106) for processing to reveal the purchase data. In some implementations, customer user device 104 may itself process the picture to reveal the purchase data.

In some implementations, customer user device 104 may receive the purchase data via an electronic copy of the sales receipt from another device (such as merchant user device 102). In some implementations, the electronic copy may be received via electronic mail, SMS, social media account, etc. In some implementations, customer user device 104 may receive an electronic copy of the sales receipt directly from merchant user device 102 via link 103. In some implementations, customer user device 104 may communicate the electronic copy to a remote device (such as reward server 106) for processing to reveal the purchase data. In some implementations, customer user device 104 may itself process the electronic copy to reveal the purchase data.

In some implementations, customer user device 104 may receive the purchase data as text that does not require image processing. For example, customer user device 104 (via email, text, link 103, etc.) may receive text that indicates the purchase data. In these implementations, customer user device 104 may communicate the text to reward server 106.

In some implementations, customer user device 104 may obtain the purchase data via a code that is input at customer user device 104 by the customer (e.g., using a keypad of the customer user device). The code may be used to look up the purchase data. In some implementations, merchant user device 102 may display the code (or a cashier may say the code), which is entered by the customer using a keypad of customer user device 104. In some implementations, customer user device 104 may communicate the code to a remote device (such as reward server 106) or may itself look up the code.

In some implementations, customer user device 104 includes a mobile device. In some implementations, the mobile device includes a digital camera (not illustrated in FIG. 1) and corresponding software allowing a user to make digital pictures of the sales receipt. In some implementations, the mobile device may include a navigation system (not illustrated in FIG. 1) such as a receiver of the Global Positioning System (GPS) and corresponding software allowing the mobile device to determine a current location of the mobile device, display maps, etc.

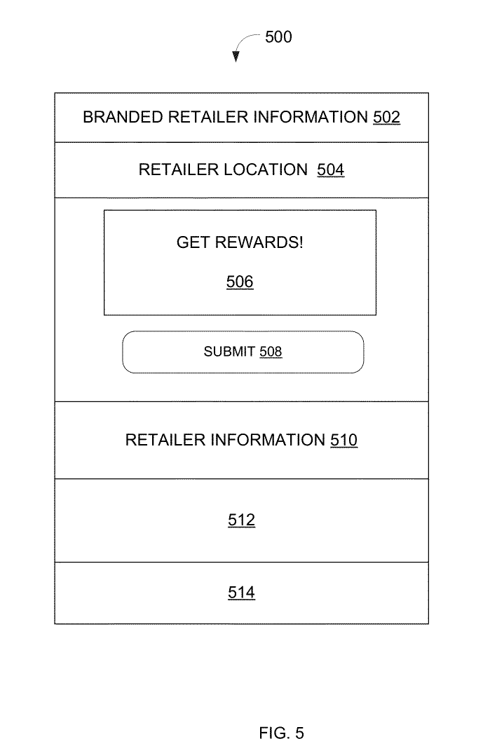

In some implementations, a customer may download and install a mobile application (exemplary screenshots of which are illustrated in FIGS. 5-8) onto the mobile device. In these implementations, the mobile application may program customer user device 104 (e.g., the mobile device) to perform the functions described herein with respect to the customer user device.

In some implementations, the mobile application may be made available for download from a memory (e.g., a non-transitory medium) associated reward server 106, a merchant, and/or from a third party application provider. In some implementations, the mobile application may be a general application that can service more than one participating merchant. In some of these implementations, the mobile application may be branded with a merchant logo or other merchant characteristics to give the appearance that the mobile application is specific for that merchant. In some implementations, the mobile application may be a specific application designed by/for a particular merchant. In some of these implementations, reward server 106 may expose or otherwise provide an application programming interface or other service that allows each mobile application to communicate with reward server 106.

A benefit of using the mobile application is ease of use and security by minimizing actions that need to be taken by the customer in order to process rewards. In some implementations, for example, the mobile application may be associated with the rewards account registered by the customer. In this manner, the mobile application may communicate with rewards server 106 and/or merchant user device 102 without having to log in to the rewards account each time the mobile application communicates with the rewards server or merchant user device. For example, using the mobile device, the customer may simply take a picture of a sales receipt or present the mobile device to the merchant and the mobile application may handle processing (including communicating/coordinating with other devices) associated with the reward program.

In some implementations, the mobile application may communicate with reward server 106 (via network 110) and/or merchant user device 102 (via link 103 or network 110). For example, the mobile application may receive the purchase data from merchant user device 102 and may communicate the purchase data (in the form of a digital representation of the sales receipt or text) to reward server 106.

In some implementations, the mobile application may be launched by the customer such as when the customer is at a merchant location. In some implementations, the mobile application may execute in the background until an indication to launch is received, such as an indication by a user or an indication that the mobile device is at or near a merchant.

In some implementations, customer user device 104 may be used to register for a rewards account. The rewards account may be associated with an account identifier that identifies an account, a name of the customer, an amount of rewards accrued by the customer, and/or other information associated with awarding the customer with rewards. In some implementations, customer user device 104 may be used to log in to an interface such as a webpage that displays the rewards account.

In some implementations, reward server 106 may include a web server 111. Web server 111 may be coupled to the reward database 130, survey database 132, profile database 134, and/or other database. The various databases may store rewards-related information such as promotional offers, buyers' data, sellers' data, transaction data, rewarding methods, and/or other rewards-related information. Information related to rewarding methods may include data identifying the types of transactions that qualify for a reward and other eligibility criteria such as reward program eligibility dates, purchase items, total price, etc.

A seller may upload information regarding promotional offers to the various databases via the web server 111. The seller may also establish new promotional offers, manage, and cancel existing promotional offers, determine rewarding methods and other criteria.

The web server 111 may be implemented as a hardware (computer or server) having software (a computer application) installed therein that helps deliver content to buyers. The web server 111 may host a website which can be accessed by buyers and sellers to participate in and/or manage reward programs according to exemplary embodiments of the present invention. The software of the web server 111 may implement the operations necessary to deliver, organize (sort) and manage promotional offers of sellers, and to participate in reward programs by buyers according to the exemplary embodiments of the present invention. In some implementations, web server 111 is configured to communicate with the customer user device 104, and the merchant user device 102 via the network 110.

In some implementations, reward server 106 may include one or more processors configured to perform some or all of a functionality of a plurality of modules. For example, the one or more processors may be configured to execute a receipt processing module 112, a reward module 113, an audit module 114, a survey module 115, a marketing module 116, a report and analysis module 117, an account management module 118, and/or other modules 119.

In some implementations, receipt processing module 112 may receive the purchase data. In some implementations, receipt processing module 112 may receive the purchase data from customer user device 104 and/or merchant user device 102. As such, in some implementations, receipt processing module 112 may receive the purchase data in formats similar to the way in which customer user device 104 receives the data.

For example, in some implementations, receipt processing module 112 may receive the purchase data as a digital representation of the sales receipt. The digital representation can include, for example, a picture of at least a portion of the sales receipt taken by the customer, an electronic document that includes the purchase data, and/or other format that can convey the purchase data. In some implementations, the digital representation can be processed by receipt processing module 112 using optical character recognition to recognize text (e.g., letters, numbers, characters, etc.) or read by a human operator. In some implementations, the digital representation includes a bar code or QR code that can be decoded by receipt processing module 112 to reveal the purchase data or a transaction identifier associated with the purchase data. In some implementations, the digital representation includes text that requires no optical recognition or decoding. For example, in these implementations, the text may be received from customer user device 104, which obtained the purchase information from the merchant using various techniques described above.

In some implementation, reward module 113 may determine a reward based on the purchase data. In some implementations, for example, a reward may vary based on a purchase amount (e.g., price paid as indicated on the sales receipt), an identity of the item that was purchased, a location where the purchase occurred, a merchant from which the item was purchased, and/or other purchase data as indicated by the sales receipt.

In some implementations, reward module 113 may receive data unrelated to the purchase data or sales receipt. For example, in some implementations, reward module 113 may receive a photograph of the customer at a merchant such as a picture of the customer eating at a restaurant. Based on the received photograph, reward module 113 may award the customer with a reward. In some implementations, reward module 113 may award the customer with a reward based on the unrelated data.

In some implementations, reward module 113 may associate the reward with the customer in a reward database 130. For example, reward database 130 may store a reward account for the customer. In some implementations, the reward account may be identified by an account identifier and may store account information such as, for example, a name of the customer, prior purchase data of the customer, rewards awarded to the customer, and/or other information. In some implementations, reward module 113 may receive the purchase data or sales receipt and the account identifier. When a reward is determined based on the purchase data or sales receipt, reward module 113 may credit the reward to the reward account associated with the account identifier (and may decrement the reward from the reward account when a reward is used). In some implementations, the purchase data, received digital representation of the sales receipt, and/or other information associated with the customer may be stored in reward database 130.

In some implementations, reward module 113 may determine a reward based on the promotional offer. For example, reward module 113 may credit a reward point (or other reward) to the customer. System 100 may be implemented such that the customer may receive a reward based on various promotional offers a particular merchant is currently making and simply walk into a merchant location (or visit a merchant's online site) in order to make a purchase that qualifies for the promotional offer.

Digital Vouchers/Coupons

In some implementations, reward module 113 may present the redeemable reward as an electronic voucher. For example, the electronic voucher may be communicated to customer user device 104, and the electronic voucher can be presented to the merchant. In some implementations, the voucher may be communicated to the merchant so that the next time the associated customer makes a purchase, the voucher may be automatically applied to the next purchase.

In some implementations, the mobile application may receive an electronic voucher from reward module 113. The electronic voucher may be in the form of a coupon or other promotion. In some implementations, the customer may present the electronic voucher to the merchant for redemption. For example, the mobile application may cause the mobile device to display the electronic voucher. In some implementations, the voucher may be displayed as a code that is entered at the merchant (e.g., using a point of sale device), a bar code or QR code that the merchant scans (e.g., using a scanner device), a graphical element that may be selected by the customer or cashier, and/or other visual cue that can be used to identify the voucher/content of the voucher.

In some implementations, reward module 113 may be configured to generate a code related to a reward. The code may include a numeric code, an alphanumeric code, a text code, a machine readable code, and/or other type of code. The code may include a non-random code, a random code, a unique code, a code uniquely associated with a particular customer and/or merchant, and/or code. An association of the code and the reward may be stored in reward database 130. The stored association may be used for audit and/or fraud detection purposes.

Reward module 113 may cause the code to be communicated for display to customer user device 104, where the code is displayed for redemption. For example, the code may be displayed or otherwise communicated from customer user device 104 to merchant user device 102 to receive from the merchant the reward associated with the code.

In some implementations, customer user device 104 may display along with the code a timer that displays a time association with reward redemption. For example, the timer may include a countdown timer that when expires such as by reaching zero, the reward may be deemed to be redeemed, expired, or otherwise unusable. In some implementations, the reward expires when the countdown timer expires. In some implementations, the reward does not expire such that the customer may simply request a new code.

In some implementations, the countdown timer may be configured by a timer source such as customer user device 104, reward module 113 (e.g., reward module 113 may communicate along with the code an instruction that includes the amount of time that the countdown timer should countdown), and/or other timer source.

In some implementations, reward module 113 may cause a description of the reward such as a free item to be communicated for display. In these implementations, customer user device 104 may display the reward.

In some implementations, merchant user device 102 may receive the code and cause the reward associated with the code to be awarded to the customer. The code may be received by various communication channels such as via an input pad of merchant user device 102, from customer user device 104 via link 103, and/or other communication channel. Merchant user device 102 may locally store an association between the reward that was awarded and the code for later auditing purposes.

In some implementations, customer user device 104 may display the code, the reward, and the countdown timer. In these implementations, the merchant may award the reward displayed on the customer user device as long as the countdown timer has not expired. The code may not be validated and may simply be recorded for auditing purposes later. For example, the reward may be related to a free brownie to be awarded to the customer. Customer user device 104 may display “free brownie” or other message that indicates the reward along with the countdown timer and the code. An employee of the merchant may award the brownie and enter the code into merchant user device 102 for later auditing.

In some implementations, merchant user device 102 may cause the reward to be awarded without first validating the code. In these implementations, merchant user device 102 need not contact reward server 106 to validate the code but instead locally keeps a record of the code and the reward so that the reward may be audited later (e.g., on a nightly basis, after an employee shift, and/or other times) during a batch or other process.

In some implementations, merchant user device 102 may validate the code with reward server 106 prior to awarding the reward. In these implementations, merchant user device 102 may validate the code on-the-fly by generating an audit request to reward server 106, whereupon the reward server 106 may validate or invalidate the code. In some implementations, merchant user device 102 may validate the code based on a local cache of valid codes and rewards previously downloaded from reward server 106.

In some implementations, audit module 114 may receive an audit request. For example, audit module 114 may receive the audit request from merchant user device 104 so that the merchant may determine whether a reward was fraudulently obtained (e.g., by an employee or other user). In some implementations, the audit request may request valid codes communicated from reward server 106. In these implementations, audit module 114 may provide the codes communicated from reward server 106 so that the merchant may locally compare the codes with the locally stored codes that were associated with reward redemptions.

In some implementations, the audit request may include one or more codes to validate. In these implementations, audit module 114 may compare the included one or more codes with the codes stored in reward database 130. When the included one or more codes does not match the codes stored in reward database 130, audit module 114 may communicate an indication that the one or more codes are invalid and may have been fraudulently entered (e.g., by an employee who made up the one or more codes to obtain an award).

Customer Service and Surveys

In some implementations, survey module 115 may obtain and store one or more survey questions to be presented as a survey to the customer. For example, a merchant may upload to reward server 106 one or more survey questions to be presented to the customer. The survey questions may be multiple-choice, open-ended, and/or other survey format. In some implementations, the customer may be awarded a reward or promotion as an incentive to complete the survey. Survey module 115 may store the survey questions in survey database 132 in association with the merchant. In some implementations, the mobile application may be branded with the merchant's information and may be pre-loaded with the one or more survey questions.

In some implementations, new survey questions may be communicated to the mobile application such that the survey questions may be dynamically updated. In some implementations, survey module 115 may receive responses to the one or more survey questions, comments from customers, and/or other information from customers and store the responses, comments, and/or other information in survey database 132.

The mobile application (or other program executing on a customer user device 104 such as, for example, electronic mail program, text messaging program, Internet browser, etc.) may present surveys associated with a purchase or merchant. For example, the mobile application may itself store or receive questions (e.g., from survey module 115) regarding a merchant, a location of the merchant, a staff member of the merchant, an item or service purchased, and/or other aspect of the purchase. The mobile application may then display the questions for the customer to answer.

Typically, though not necessarily, the mobile application presents the survey soon after the purchase data is submitted. In some implementations, the purchase data is associated with the survey results. In some implementations, the association is stored in reward database 130 and/or survey database 132. For example, the mobile application or other device that receives the survey and purchase data may link the purchase data and the survey results based on a time each was received and/or by an identifier links the purchase data and the survey results. In some implementations, the survey may be deployed with varying frequency. For example, the survey may be presented with every purchase transaction or once for every five transactions.

In some implementations, a survey may be customized depending on a profile or habit of the customer. For example, a customer who purchases wine may be asked to rate the wine list of a merchant.

In some implementations, the survey results may be stored in a database locally at the mobile device or remotely at, for example, reward database 130 and/or survey database 132. In some implementations, survey results may be grouped by merchant, a location of the merchant, a staff member of the merchant, an item or service purchased, time/date the purchase was made, and/or by other metric for which the survey data pertains. In this manner, each merchant, location, etc., may be associated with various customer ratings.

In some implementations, feedback and/or commentary may be forwarded to customer service agents or managers of the merchant by email, SMS, website, and/or other communication channel that can be used to convey such information. In some implementations, the feedback may be indicated as negative, positive, neutral, or other designation. In some implementations, certain types of feedback (negative, positive, neutral, etc.) may be forward to customer service agents or managers using various communication channels.

Direct Marketing

In some implementations, marketing module 116 may generate marketing campaigns based on a purchase history of a customer. For example, the purchase history may be generated based on the receipts (or purchase data) submitted by the customer. Marketing module 116 may analyze the purchase history and generate a customer profile, which may be used to generate a marketing campaign (e.g., a direct 1-to-1 marketing campaign) tailored for the customer.

In some implementations, the marketing campaign may include promotional offers and digital coupons for the customer depending on the customer profile. For example, customers who frequently dine out may be offered promotions related to dining such as a free dessert or a 20% discount on a next meal. For customers who eat by themselves, as indicated by for example a single portion purchase, the marketing campaign may include offers that encourage a group visit such as 20% off for parties of two or more.

In some implementations, the marketing campaign may include offers related to the item purchased. For example, vegetarian specials may be communicated to customers who purchase salads and wine specials may be communicated to customers who purchase wine. For customers who eat at a certain location, they can be sent offers only for that location only or offers enticing them to visit a new or different location. In some implementations, offers may be based on an amount of money a customer has spent over a certain period of time, such as within the last 90 days.

In some implementations, offers may be based on a frequency of receipt/purchase data submissions. For example, customers who have not submitted a receipt in the last 30 days may be sent an offer to incentivize them to make a purchase and submit a receipt. In some implementations, offers may be based on external data such as weather (rain, temperature, events, etc.). In some implementations, a location of the customer (determined, e.g., via GPS location data or other location information) may be used to customize promotional offers. For example, offers from merchants or locations nearby a customer may be sent to the customer.

In some implementations, the offers of the marketing campaign can be created and communicated to the customer via a website, a mobile application, SMS, social media site, and/or other communication channel. In some implementations, the offers may be automatically sent when certain conditions are met (such as when the temperature in the vicinity of the customer drops below 20 F degrees).

Analytics/Dashboard

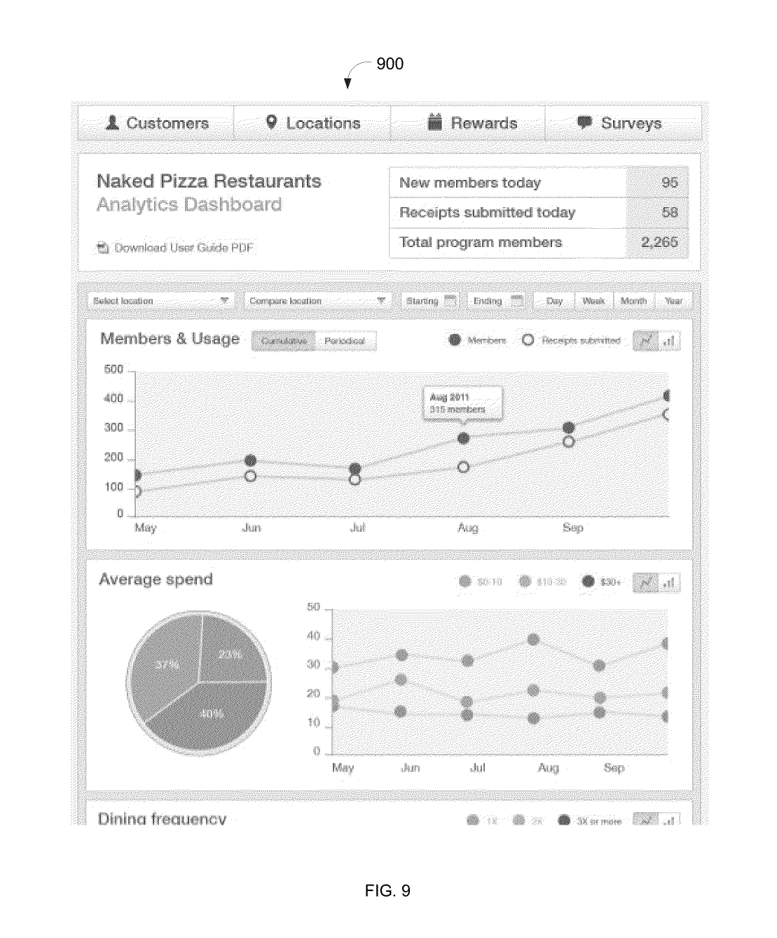

In some implementations, report and analysis module 117 may generate a Dashboard that includes various reports and analytics (examples of which are illustrated by FIGS. 9-12) that may be used to review, monitor, and manage customer data. In some implementations, the Dashboard may be displayed via a website or other user interface that the merchant or others may access. In some implementations, the purchase data, submitted receipts, customer profile, promotions or vouchers communicated to the customer, promotions or vouchers redeemed by the customer, survey feedback, and/or other customer information may be displayed by the Dashboard, which displays the data in an easily analyzable format.

In some implementations, the Dashboard may be parsed by individual customer, customer group, merchant location, merchant offer (digital voucher or coupon created for customers), survey feedback, and/or by other customer information.

In some implementations, the Dashboard may include an analytical representation of data includes charts, graphs, tables, customer profiles, etc. In some implementations, the Dashboard can include data from an individual merchant, data from merchants handled by reward server 106, or data external to merchants. In this manner, a particular merchant may compare their performance with another merchant's performance. For example, a restaurant may compare their monthly sales among their own locations to other merchants' sales or to industry-wide sales).

In some implementations, account management module 118 may be configured to create, manage, and update various profiles associated with the rewards program. For example, the profiles may include a merchant account profile, a buyer account profile, and/or other profiles.

The merchant account profile may include merchant profile information such as a name of business, a type of business, an address, a contact information, an available promotional offers, a ratings, a rankings, a commentary of users, and/or other information. The buyer account profile may such buyer profile information such as a name, information of accepted promotional offers, information about redeemed offers, earned points, and/or other buyer profile information.

By allowing a customer to show proof of purchase using his mobile device (as an example), system 100 facilitates an improved way to administer rewards without the need for reward cards or enticing the customer with particular promotional offers before making the purchase. Instead, a customer may walk into a merchant location (or navigate to a merchant's online site), make a purchase, obtain a digital representation of a sales receipt, and obtain a reward based on the purchase.

As used herein, the term “user device” (such as the customer user device 104 and the merchant user device 102) refers to a mobile device, a terminal, user equipment, a portable communication device, a computer, a portable computing device, a personal digital assistant (PDA), or some other electronic device with ability to receive and transmit data via cable or wireless network (e.g. with ability to browse the Internet.).

As used herein, the term “mobile device” refers to handheld devices carried by customers. For example, a mobile device may be a handheld cellular phone, a mobile phone, a smart phone, a cordless telephone, a handheld device having wireless connection capability, or some other suitable processing device with ability to receive and transmit data via cable or wireless network. Accordingly, one or more aspects taught herein may be incorporated into a phone (e.g., a cellular phone or smart phone), a computer (e.g., a laptop), a portable communication device, a portable computing device, a global positioning system device, or any other suitable device that is able to communicate via a wireless medium.

As used herein, the term “promotion,” “offer” or “promotional offer” is used to refer to a financial discount, rebate, reward, coupon or other promotional feature provided to a customer by a merchant. The term “customer” as used herein is intended to refer to a buyer or a consumer and defines any individual or entity that makes purchases. The term “merchant” is used herein to refer to a seller, retailer, distributor, trader, etc. It should be understood that merchants sell commodities (products or services) to customers at stores, shops, malls, restaurants, bistros, hotels, rental offices, transport companies, electronic commerce (e.g., websites), etc.

According to the exemplary embodiment, distance between the current location of the customer user device 104 and the seller's address can be calculated based on location information determined through the GPS receiver, or data received from the base stations of the cellular network, or IP address obtained from the access point providing cable or wireless connection to the user device 104, or a combination thereof. Those who are skilled in the art can readily understand that any other appropriate way of determining current location of the customer user device 104 can be used.

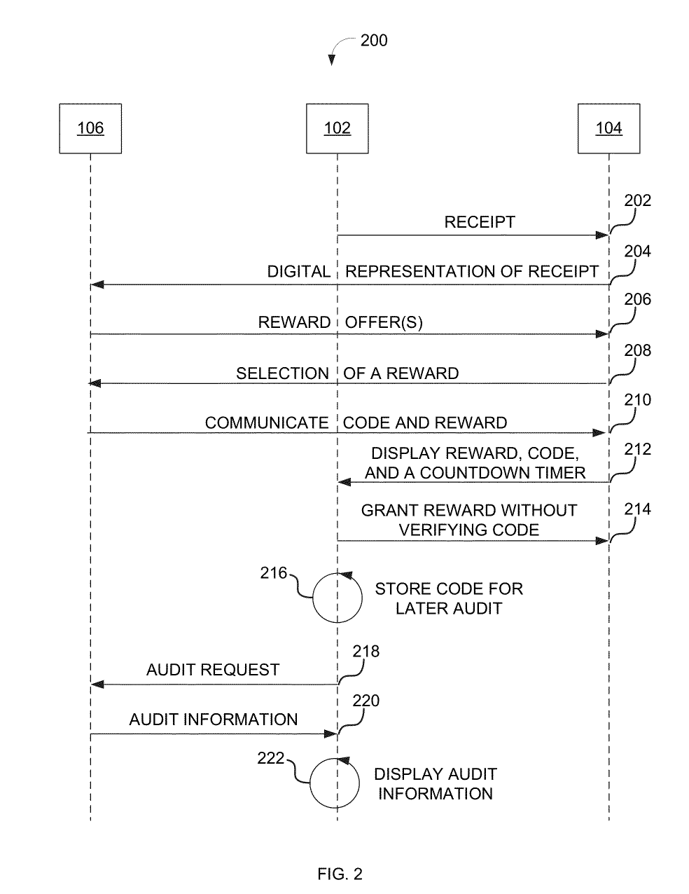

FIG. 2 is a data flow diagram illustrating a process 200 for providing a card-less reward program and fraud detection, according to various implementations of the invention. Although some of the operations of process 200 may be discussed below with respect to the components of system 100 described above and illustrated in FIG. 1, it should be appreciated that this is for illustrative purposes only, and that process 200 may be implemented with alternative components and/or systems without departing from the scope of this disclosure. Further, the particular arrangement of the operations illustrated in FIG. 2, other drawing figures and described hereafter is not intended to be limiting. In some implementations, various ones of the operations could be performed in an order other than the one set forth, various ones of the operations may be combined with others and/or be omitted altogether, and/or various additional operations may be added without departing from the scope of the disclosure, as should be appreciated.

In an operation 202, a sales receipt may be communicated from merchant user device 102 to customer user device 104. For example, a customer operating customer user device 104 may have made a purchase and received a sales receipt from merchant user device 102. In an operation 204, a digital representation of the sales receipt may be communicated from customer user device 104 to reward server 106. In an operation 206, one or more reward offers may be communicated from reward server 106 to customer user device 104. In an operation 208, customer user device 104 may communicate a selection of a reward to reward server 106. In an operation 210, reward server 106 may communicate a code related to the reward and the reward to customer user device 104. In an operation 212, customer user device 104 may display or otherwise communicate the code and a description of the reward. In some implementations, customer user device 104 displays a countdown timer, which may be configured by various countdown timer sources. In an operation 214, merchant user device 102 may cause the reward to be awarded to the customer without verifying the code, but storing the code for later audit purposes in an operation 216. In an operation 218, merchant user device 102 may communicate an audit request to reward server 106. In an operation 220, reward server 106 may communicate audit information to merchant user device 102 based on the audit request. In some implementations, the audit information may include valid codes associated with the merchant, customer user device 104, and/or other device, user, or account. In some implementations, the audit information may include an indication that a particular code may have been fraudulently entered. In an operation 222, merchant user device 102 may display the audit information to determine whether one or more codes have been fraudulently entered based on the audit information.

The various information illustrated as being communicated from one device to another device is illustrative only. For example, information may be communicated from one device to another device via one or more intermediary devices even though such intermediary devices are not illustrated.

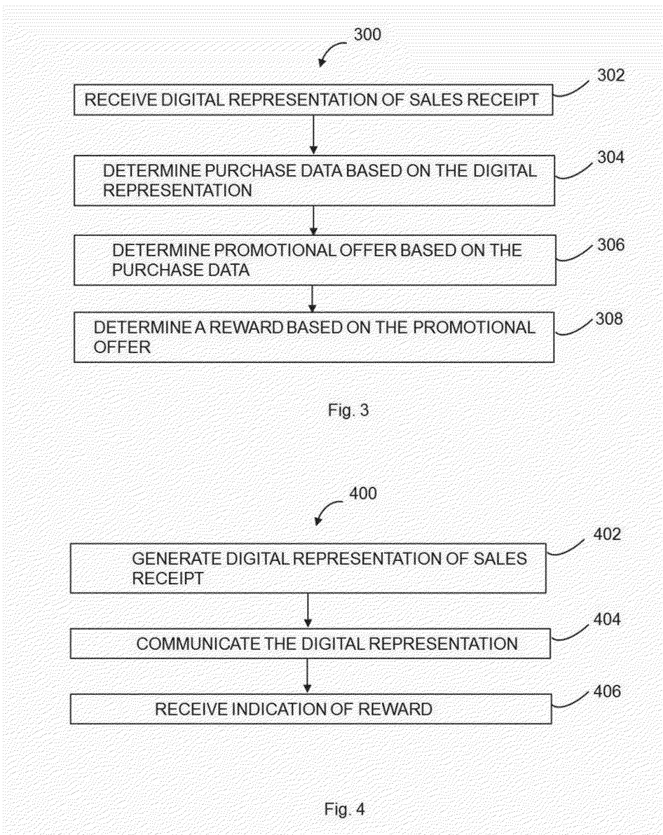

FIG. 3 is a flow diagram illustrating a process 300 for providing a card-less reward program at a reward server, according to various implementations of the invention. In some implementations, in an operation 302, process 300 may include receiving a digital representation of at least a portion of a sales receipt. The digital representation may include, for example, a picture of a printed sales receipt, an electronic file that when printed resembles the sales receipt (other than a picture file such as a portable document format file), a text formatted file that requires no processing to retrieve the purchase data (other than reading the file), and/or other representation that can be processed using a computing device. In some implementations, the picture or electronic file includes a bar code or QR code that can be decoded to obtain the purchase data.

In some implementations, in an operation 304, process 300 may include determining purchase data associated with the receipt based on the digital representation. For example, when the digital representation is a picture or other file that may be image-processed (which includes decoding a bar code or QR code), determining the purchase data may include processing the picture using optical character recognition or decoding a bar code or QR code. When the digital representation is a text file, determining the purchase data may include parsing the text file.

In some implementations, in an operation 306, process 300 may include determining whether a promotional offer is available based on the purchase data. For example, in operation 306, process 300 may determine that a promotional offer for the merchant associated with the purchase is available.

In some implementations, in an operation 308, process 300 may include determining a reward based on the promotional offer. For example, in operation 308, process 300 may determine that a reward point for every dollar spent at the merchant should be awarded to the customer.

FIG. 4 is a flow diagram illustrating a process 400 for providing a card-less reward program at a mobile device, according to various implementations of the invention.

In some implementations, in an operation 402, process 400 may include generating a digital representation of at least a portion of a receipt. In some implementations, generating the digital representation may include generating a photographic image (i.e., a picture) of the sales receipt. In some implementations, generating the digital representation may include receiving the digital representation from a remote source and locally storing the representation.

In some implementations, in an operation 404, process 400 may include communicating the digital representation to a reward server. In some implementations, image processing (such as by optical character recognition or bar code/QR code decoding) may be applied to the digital representation to determine purchase data encoded in the digital representation. In some implementations, the reward server may perform the image processing. In some implementations, image processing is performed in operation 402 (such as locally at a mobile device).

In some implementations, in an operation 406, process 400 may include receiving an indication of a reward from a reward server, wherein the reward is determined based on the digital representation.

FIG. 5 is a screenshot that illustrates a user interface 500 for submitting a sales receipt, according to various implementations of the invention. The screenshot illustrated in FIG. 5 and other screenshot illustrations are exemplary only and should not be viewed as limiting. Various illustrated portions, graphical elements, and configurations that rearrange or omit certain portions/elements may be used as would be appreciated.

Referring to FIG. 5, user interface 500 may be generated by a mobile application and displayed by a mobile device, although other applications and devices may be used. In some implementations, a portion 502 of user interface may include branding or other identifier for a merchant.

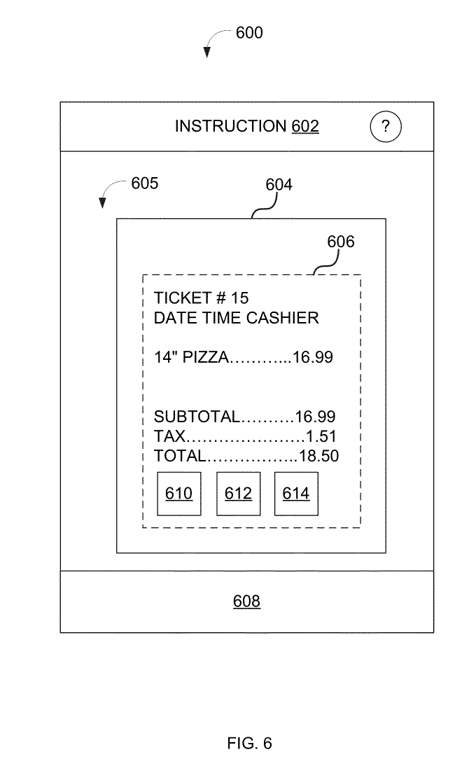

In some implementations, portions 504 and 510 display a location identifier, address and links to mapping and phone contacts. In some implementations, portion 506 may be used to the merchant displays information related to offers and rewards that may be received. In some implementations, portion 508 launches a submission process to submit an electronic representation of a sales receipt. In some implementations, for example, by selecting the “Submit” button of portion 508, the photo interface illustrated in FIG. 6 may be displayed.

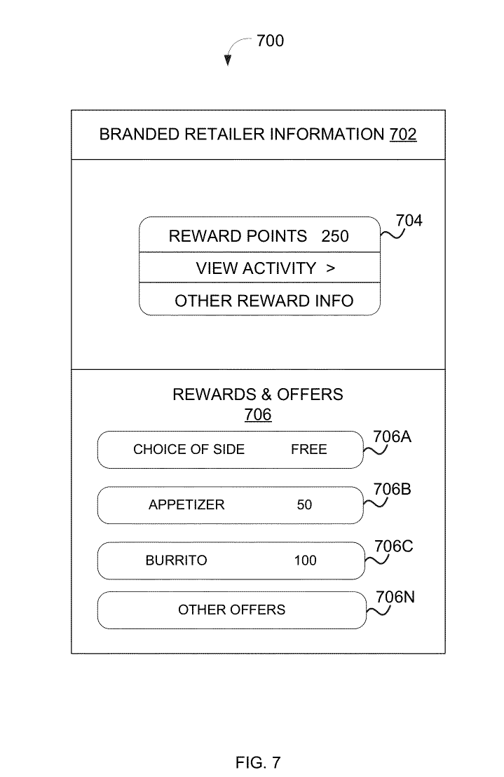

In some implementations, portion 512 may include links to various email and social media sites associated with the merchant. In some implementations, portion 514 may include a navigation toolbar that shows locations of the merchant, rewards associated with the merchant (such as the rewards illustrated in FIG. 7), and information associated with the merchant.

FIG. 6 is a screenshot that illustrates a user interface 600 for taking a picture of a sales receipt, according to various implementations of the invention. In some implementations, portion 602 of user interface 600 may include an instructional banner and a help button “?” that links to further information that guides how to take the picture. Imaging portion 605 may include an area captured by an image capture device such as a camera. Imaging portion 605 may include all or a portion of a sales receipt 604. In some implementations, portion 606 (illustrated in dotted lines) may highlight at least a portion of sales receipt 604 that is being taken and/or will be processed. For example, portion 604 indicates which portion of sales receipt 604 will be photographed and/or processed. In some implementations, portion 604 need not include the entire sales receipt 604 as long as the purchase data, merchant identification, and/or other information from the sales receipt is imaged and/or processed. In this manner, the customer may guide relevant portions (or all) of the sales receipt to be photographed based on portion 606. In some implementations, portion 608 may leverage native camera interface elements of the mobile device to cause a picture or video of the receipt to be taken. In some implementations, sales receipt 604 may include a bar code 610, a QR code 612, and/or other machine readable codes 614 that include purchase data of sales receipt 606.

FIG. 7 is a screenshot that illustrates a user interface 700 for presenting rewards and offers, according to various implementations of the invention. In some implementations, portion 702 of user interface 700 may be used to show branding (similar to portion 502 of FIG. 5). In some implementations, portion 704 may be used to display rewards already accumulated by the customer for the particular merchant identified in portion 704 (although a general reward that applies to different merchants may be used as well), view reward activity, and/or view other reward information. In some implementations, portion 706 may be used to display offers (illustrated as offers 706A, 706B, 706C, . . . , 706N) and reward points necessary to redeem the offers. In some implementations, the customer or cashier of the merchant may select the appropriate offer/reward for redemption, which may then cause the reward “cost” to be decremented from the customer's accumulated rewards displayed at portion 704.

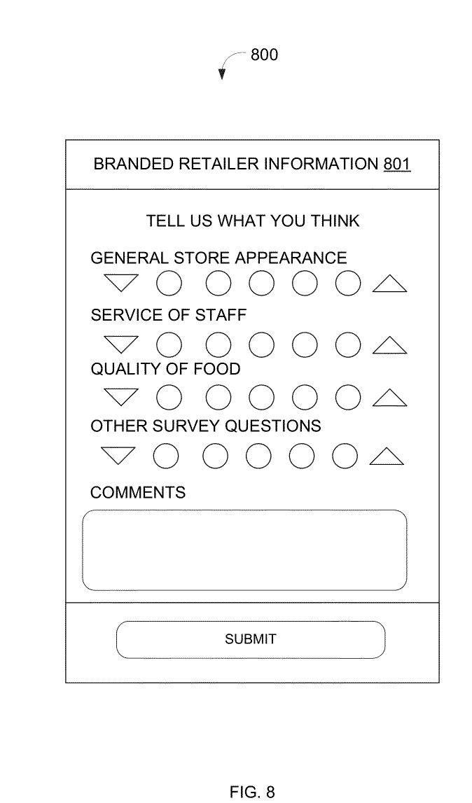

FIG. 8 is a screenshot that illustrates a user interface 800 for presenting a survey associated with a purchase, according to various implementations of the invention. In some implementations, user interface 800 is displayed after a purchase or reward redemption is made so that the customer may rate the merchant according to various metrics/questions presented in portion 802. As illustrated in FIG. 8, the survey may include multiple choice style questions as well as an open or free-form text input (e.g., for general comments). In some implementations, user interface 800 is displayed after each purchase or reward redemption or after a predefined number of purchases or redemptions (e.g., once for each five purchases).

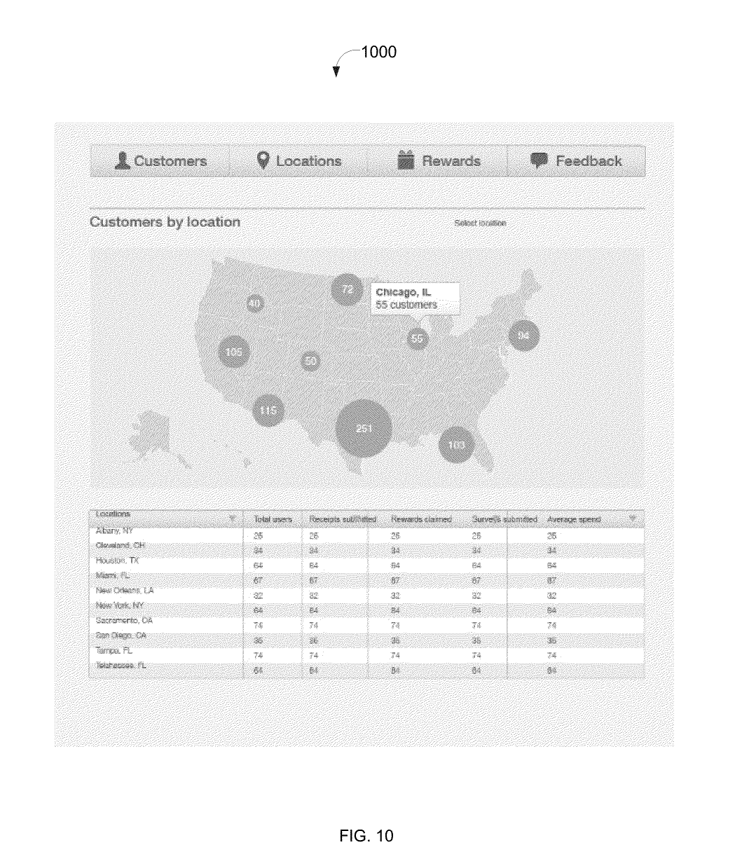

FIG. 9 is a screenshot that illustrates a user interface 900 for displaying analytics associated with a card-less reward program, according to various implementations of the invention. In some implementations, the user interface of FIG. 9 (and interfaces illustrated in FIGS. 10-12) may be one of various interfaces of a Dashboard interface that illustrates analytics and metrics associated with a card-less reward program described herein. In some implementations, each of the user interfaces illustrated in FIGS. 9-12 may include a navigation toolbar that allows drill-down/group-by views of the data, providing rich and multi-dimensional analysis of the rewards program. For example, the navigation toolbar may include analytics associated with customers, locations of the merchant, rewards and redemptions associated with the merchant, and surveys associated with the merchant.

Referring to FIG. 9, user interface 900 may include general information such as, for example, “new members today,” which indicates a number of members who have registered for the rewards program associated with the merchant, “receipts submitted today,” which indicates a number of receipts submitted by customers as described herein, and “total program members,” which indicates a number of customers that have registered for the rewards program.

In some implementations, user interface 900 may include various graphical elements such as charts. In some implementations, the graphical elements may include a members and usage chart that graphically displays a number of members and receipts submitted over time. In some implementations, the graphical elements may include a pie chart that displays average money spent per submitted receipt, which may be grouped by (e.g., each slice representing) ranges of dollars spent. In some implementations, the graphical elements may include a line chart that displays average amounts spent over time. As would be appreciated, various other types of graphical elements other than line and pie charts may be used.

FIG. 10 is a screenshot that illustrates a user interface 1000 for displaying analytics grouped by location in association with a card-less reward program, according to various implementations of the invention. In some implementations, the Dashboard may display analytics and metrics by location. For example, as illustrated in FIG. 10, a geographic map showing locations of the merchant may be displayed. Each location on the map may be associated with a graphical object (illustrated as a circle enclosing a number) that indicates a number of customers who submitted receipts (and therefore relative success of the reward program for each location) or other metric that can be used to assess a location's success.

In some implementations, a table that illustrates a listing of different locations may be displayed. In some implementations, each location may correspond to a row of the table. In some implementations, each column of the table may display a different metric by which to assess a location. For example, columns may include “total users,” “receipts submitted,” “rewards claimed,” “surveys submitted,” and “average spend” (which averages total amounts spent per submitted receipt).

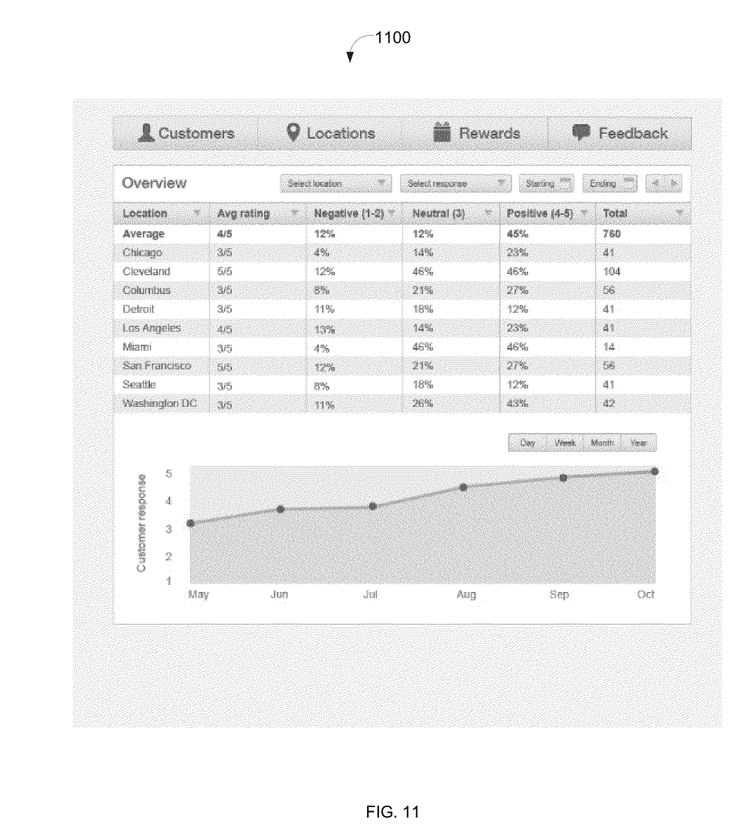

FIG. 11 is a screenshot that illustrates a user interface 1100 for displaying survey results grouped by location in association with a card-less reward program, according to various implementations of the invention. In some implementations, user interface 1100 may display survey results for different locations of the merchant. In some implementations, the results may be interrogated such that the results may be filtered (show only) by: a particular location; a particular survey response (e.g., negative feedback, neutral feedback, and positive feedback); and a start date or end date when the survey was received.

In some implementations, a table showing each location and their corresponding: average survey response (e.g., a “1/5,” a “2/5,” a “3/5,” a “4/5,” a “5/5” average response rating), number of negative responses (e.g., responses of 1 or 2), number of neutral responses (e.g., a 3), number of positive responses (e.g., a 4 or 5), and total number of survey responses. In some implementations, user interface 1100 includes a line graph that illustrates a number of customer survey responses received over time.

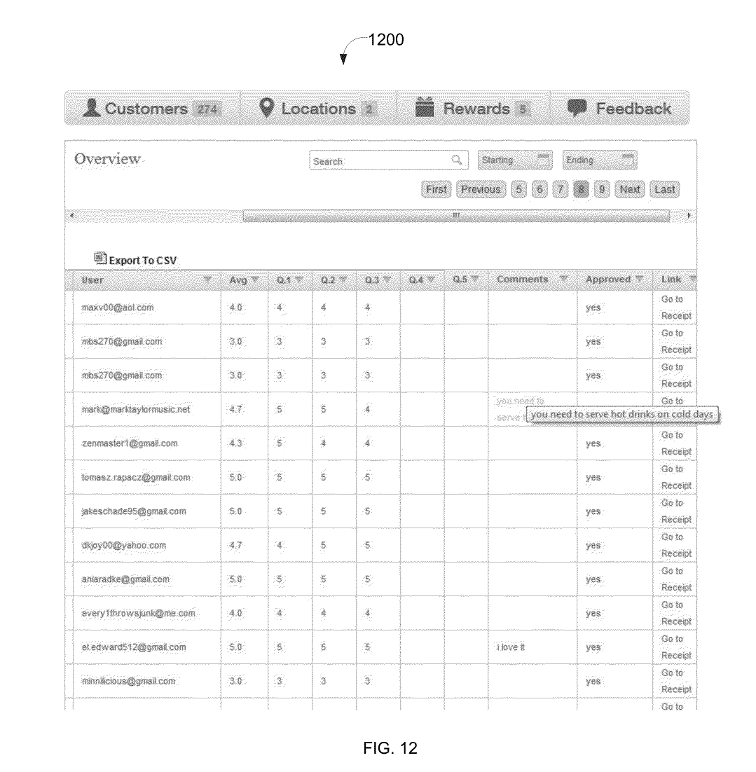

FIG. 12 is a screenshot that illustrates a user interface 1200 for displaying survey results by individual customers in association with a card-less reward program, according to various implementations of the invention. User interface 1200 may be used to drill-down to individual customer survey responses. In some implementations, the results of user interface 1200 may be queried by starting or ending date and/or by location. In some implementations, user interface 1200 may display a table, where each row includes a customer identifier, which may be indicated by an email address of the customer. In some implementations, the table may include various columns that describe a user's ratings such as, for example, an “Avg” or average rating given by the customer for a merchant/location/cashier/etc., a response to “Q.1” or question 1 and various other questions, a comment entered by the customer, and a link to the receipt submitted by the customer in association with the survey.

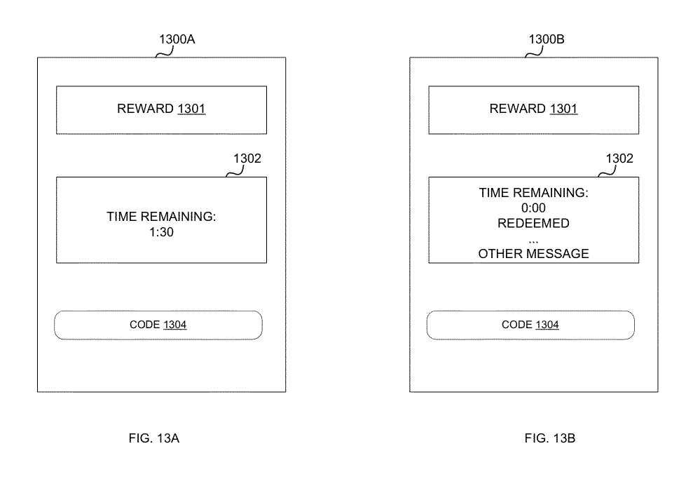

FIGS. 13A and 13B are screenshots that illustrate user interfaces 1300A and 1300B for displaying a reward, a code, and a countdown timer, according to various implementations of the invention. The user interfaces 1300A and 1300B may be displayed by customer user device 104 and/or other device that can present the code for redemption of a reward. Referring to FIGS. 13A and 13B, the user interfaces may include a reward description 1301 such as a “free brownie” message. Reward description 1301 may be used by the merchant to identify the reward to award to the customer. Countdown portion 1302 may display a countdown timer that indicates a time remaining to redeem the reward. Code 1304 may display a code related to the reward.

Referring to FIG. 13B, the countdown timer has expired and countdown portion 1302 may indicate that the countdown timer has expired, the reward was redeemed, and/or other message that indicates that the countdown timer has expired.

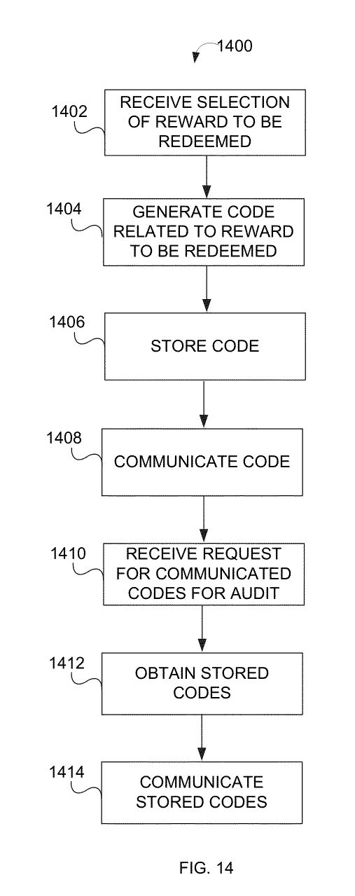

FIG. 14 is a flow diagram illustrating a process 1400 for providing an audit of codes related to rewards for fraud detection, according to various implementations of the invention. In an operation 1402, a selection of a reward to be redeemed may be received. In an operation 1404, a code related to the reward to be redeemed may be generated. In an operation 1406, the code may be stored in association with the reward to be redeemed. In an operation 1408, the code may be communicated. For example, the code may be communicated to a customer user device. In an operation 1410, an audit request may be received that requests communicated codes. For example, the audit request may be received from a merchant that wishes to determine whether one or more codes were fraudulently entered by an employee or other user. In an operation 1412, the stored codes may be obtained and in an operation 1414, the stored codes may be communicated.

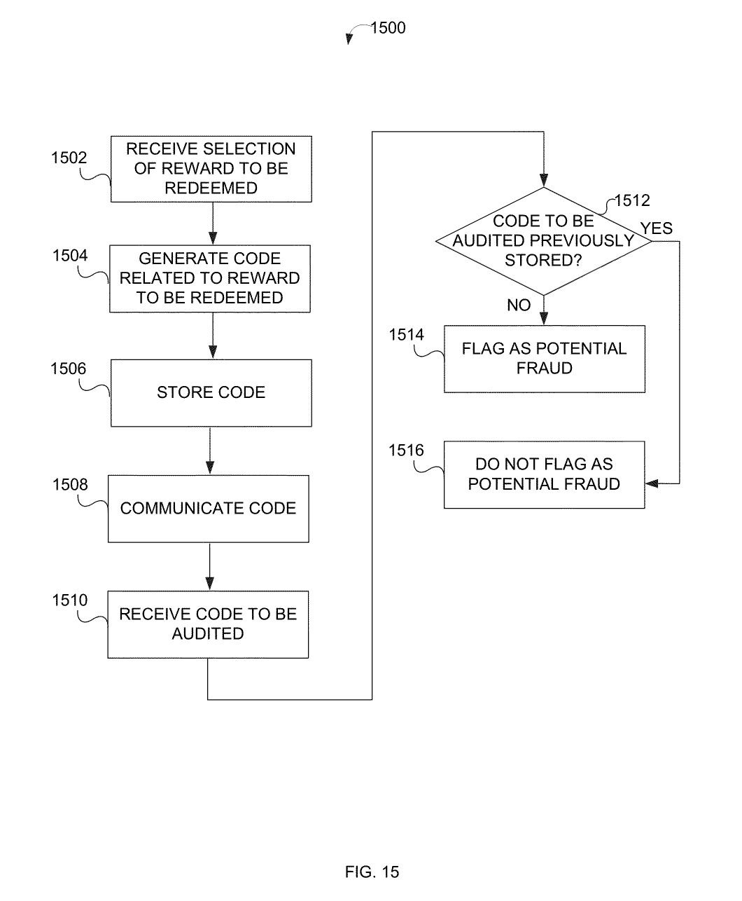

FIG. 15 is a flow diagram illustrating a process 1500 for flagging potentially fraudulently entered codes, according to various implementations of the invention. In an operation 1502, a selection of a reward to be redeemed may be received. In an operation 1504, a code related to the reward to be redeemed may be generated. In an operation 1506, the code may be stored in association with the reward to be redeemed. In an operation 1508, the code may be communicated. For example, the code may be communicated to a customer user device. In an operation 1510, a code to be audited may be received. For example, the code to be audited may be received from a merchant that wishes to determine whether the code was fraudulently entered by an employee or other user. In an operation 1512, a determination of whether the code to be audited was previously stored (e.g., is a valid code that was previously communicated and stored) may be made. If the code to be audited has been previously stored (e.g., is likely valid), the code to be audited may not be flagged as potential fraud in an operation 1516. On the other hand, if the code to be audited has not been previously stored (e.g., is likely invalid), the code to be audited may be flagged as potential fraud in an operation 1514.

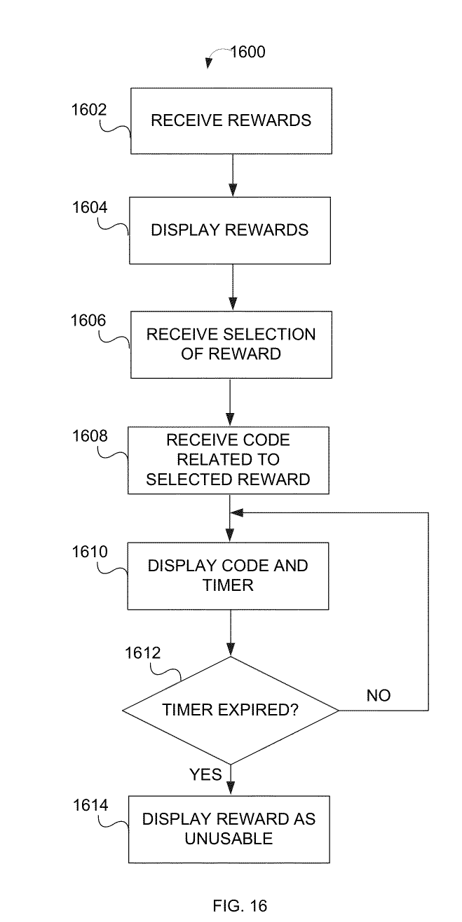

FIG. 16 is a flow diagram illustrating a process 1600 for displaying codes for redemption of rewards, according to various implementations of the invention. In an operation 1602, one or more rewards may be received such as from reward server 106. In an operation 1604, the one or more rewards may be displayed. In an operation 1606, a selection of a reward may be received and communicated to reward server 106. In an operation 1608, a code related to the selected reward may be received from reward server 106. In an operation 1610, the code and a countdown timer may be displayed. In an operation 1612, a determination of whether the countdown timer has expired may be made. If the countdown timer has not expired, process 1600 may return to operation 1610, where the code and countdown timer may be displayed. If the countdown time has expired, the reward may be displayed as unusable in an operation 1614.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description of the disclosed aspects is provided to enable any person skilled in the art to make or use the present disclosure. While a particular form of the invention has been illustrated and described, it will be apparent that various modifications can be made without departing from the spirit and scope of the invention. Accordingly, it is not intended that the invention be limited, except as by the appended claims. Various modifications to these aspects will be readily apparent to those skilled in the art, and the generic principles defined herein may be applied to other aspects without departing from the scope of the disclosure. The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other articles, not necessarily the article described above. The elements and acts of the various embodiments described above can be combined to provide further embodiments.

The above description provides specific details for a thorough understanding of the invention. One skilled in the art will understand that the invention may be practiced without such details. In other instances, well-known structures and functions have not been shown or described in detail to avoid unnecessarily obscuring the description of the embodiments.

The word “exemplary” is used in this description to mean “serving as an example, instance, or illustration”. Any embodiment described herein as “exemplary” is not necessarily to be construed as preferred or advantageous over other embodiments. Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

Particular terminology used when describing certain features or aspects of the invention should not be taken to imply that the terminology is being redefined herein to be restricted to any specific characteristics, features, or aspects of the invention with which that terminology is associated. In general, the terms used in the appended claims should not be construed to limit the invention to the specific embodiments disclosed in the specification, unless the Detailed Description section explicitly defines such terms. Accordingly, the actual scope of the invention encompasses not only the disclosed embodiments, but also all equivalent ways of practicing or implementing the invention.

Those of skill in the art would understand that any of the various illustrative logical blocks, modules, processors, means, and algorithm steps described in connection with the aspects disclosed here may be implemented as electronic hardware (for example, a digital implementation, an analog implementation, or a combination of said two, which may be designed using source coding or some other technique), various forms of program or design code incorporating instructions (which may be referred to herein, for convenience, as “software”), firmware, or combinations of the above. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Those who are skilled in the art may implement the described functionality in varying ways for each particular application, but such implementation decisions should not be interpreted as causing a departure from the scope of the present disclosure.

If implemented in software, the functions may be stored on or transmitted over as one or more instructions or code on a computer-readable medium. A computer-readable medium can include a non-transitory storage media or communication media including any medium that facilitates transfer of a computer program from one place to another. A non-transitory storage media may be any available media that can be accessed by a computer. By way of example, and not limitation, such non-transitory storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

It should be appreciated that a computer readable medium may be implemented in any suitable computer-program product.

For a hardware implementation, embodiments can be implemented with processors, controllers, micro-controllers, microprocessors, electronic devices, other electronic units designed to perform the functions described herein, or a combination thereof. Memory can be implemented within the processor or external to the processor. As used herein the term “memory” refers to any type of long term, short term, volatile, nonvolatile, or other storage devices and is not to be limited to any particular type of memory or number of memories, or type of media upon which memory is stored. For a firmware and/or software implementation, embodiments can be implemented with modules such as procedures, functions, and so on, that perform the functions described herein. Any machine readable medium tangibly embodying instructions can be used in implementing the embodiments described herein.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for providing rewards based on digital representations of receipts, the method being implemented in a computer that includes one or more processors programmed by one or more computer program modules, the method comprising:
receiving, by a receipt processing module, a digital representation of at least a portion of a receipt;
determining, by the receipt processing module, purchase data associated with the receipt based on the digital representation;
determining, by a reward module, whether a promotional offer is available based on the purchase data; and
determining, by the reward module, a reward based on the promotional offer.

2. The method of claim 1, wherein the digital representation comprises a digital image.

3. The method of claim 2, wherein the digital image comprises a photographic or video image of at least a portion of the receipt, and wherein determining purchase data comprises processing the photographic image using optical character recognition.

4. The method of claim 2, wherein the digital image comprises a photographic image of a bar code or QR code printed on the receipt, and wherein determining purchase data comprises decoding the bar code or QR code.

5. The method of claim 1, wherein the digital representation comprises a decoded identifier associated with a bar code or QR code or alphanumeric code, and wherein determining purchase data comprises looking up the purchase data based on the decoded identifier.

6. The method of claim 1, further comprising communicating a message associated with the reward.

7. The method of claim 1, further comprising crediting an account of a buyer based on the reward.

8. The method of claim 1, further comprising:
communicating, by a survey module, a customer survey;
receiving, by the survey module, feedback in response to the customer survey; and
associating, by the survey module, the feedback with the receipt.

9. The method of claim 1, further comprising:
determining, by the marketing module, a direct marketing offer based on the purchase data.

10. The method of claim 1, further comprising:
generating a coupon based on the reward;
receiving an indication that the coupon has been redeemed; and
decrementing a total reward for a user based on the indication that the coupon has been redeemed.

11. The method of claim 1, further comprising:
generating, by a report and analysis module, analytics based on the purchase data, the reward, or the feedback.

12. The method of claim 1, further comprising:
generating, by the reward module, a code related to the reward;
causing, by the reward module, the code to be communicated in relation to the reward; and
storing, by the reward module, an association of the code and the reward.

13. The method of claim 12, further comprising:
receiving, by an audit module, an audit request;
obtaining, by the audit module, at least the code based on the audit request; and
causing, by the audit module, the at least the code to be communicated.

14. The method of claim 12, further comprising:
receiving, by an audit module, an audit request comprising a code to be audited;
determining, by the audit module, whether the code to be audited is stored in association with one or more rewards; and
determining, by the audit module, whether the code to be audited should be flagged as potentially fraudulent based on whether the code to be audited is stored in association with one or more rewards.

15. A reward server for providing promotional rewards, the server comprising:
one or more processors configured to execute computer program modules, the computer program modules comprising:
a receipt processing module configured to:
receive a digital representation of at least a portion of a receipt;
determine purchase data associated with the receipt based on the digital representation; and
a reward module configured to:
determine whether a promotional offer is available based on the purchase data; and
determine a reward based on the promotional offer.

16. The server of claim 15, wherein the digital representation comprises a digital image.

17. The server of claim 16, wherein the digital image comprises a photographic or video image of at least a portion of the receipt, and wherein the receipt processing module is configured to process the photographic image using optical character recognition to determine the purchase data.

18. The server of claim 16, wherein the digital image comprises a photographic or video image of a bar code or QR code printed on the receipt, and wherein the receipt processing module is configured to decode the bar code or QR code to determine the purchase data.

19. The server of claim 15, wherein the digital representation comprises a decoded identifier associated with a bar code or QR code, and wherein the receipt processing module is configured to look up the purchase data based on the decoded identifier to determine the purchase data.

20. The server of claim 15, wherein the reward module is further configured to communicate a message associated with the reward.

21. The server of claim 15, wherein the reward module is further configured to credit an account of a buyer based on the reward.

22. The server of claim 15, further comprising:
a survey module configured to:
communicate a customer survey;
receive feedback in response to the customer survey; and
associate the feedback with the receipt.

23. The server of claim 15, further comprising:
a marketing module configured to:
determine a direct marketing offer based on the purchase data.

24. The server of claim 15, wherein the reward module is further configured to:
generate a coupon based on the reward;
receive an indication that the coupon has been redeemed; and
decrement a total reward for a user based on the indication that the coupon has been redeemed.

25. The server of claim 15, further comprising:
a report and analysis module configured to:
generate analytics based on the purchase data, the reward, or the feedback.

26. A method for obtaining promotional rewards, comprising:
generating, by a mobile device, a digital representation of at least a portion of a receipt;
communicating, by the mobile device, the digital representation to a reward server; and
receiving, by the mobile device, an indication of a reward from the reward server, wherein the reward is determined based on the digital representation.

27. The method of claim 26, wherein generating a digital representation comprises generating a digital image.

28. The method of claim 26, wherein generating a digital image comprises generating a photographic image of at least a portion of the receipt.

29. The method of claim 26, wherein generating a digital image comprises generating a photographic image of a bar code or QR code printed on the receipt.

30. The method of claim 26, wherein generating a digital representation comprises decoding the bar code or QR code and determining an identifier encoded by the bar code or QR code.

31. The method of claim 26, wherein generating a digital representation comprises receiving the digital representation from a remote device via near-field communication.

32. The method of claim 26, further comprising receiving and displaying a message associated with the reward.

33. The method of claim 26, further comprising:
receiving, by the mobile device, a customer survey from the reward server;
receiving, by the reward server, feedback from a user in response to the customer survey; and
communicating, by the mobile device to the reward server, the feedback.

34. The method of claim 26, further comprising:
receiving, by the mobile device from the reward server, a direct marketing offer based on the purchase data.

35. The method of claim 26, further comprising:
receiving, by the mobile device from the reward server, a coupon based on the reward; and
presenting, by the mobile device, the coupon for redemption.

36. The method of claim 26, further comprising:
receiving, by the mobile device a code related to the reward; and
displaying, by the mobile device, a timer, wherein the reward is displayed as unusable after the timer reaches a predetermined time.
